(19) United States
(12) Patent Application Publication
(10) Pub. No.: US 2023/0060159 A1
(43) Pub. Date: Mar. 2, 2023

(54) SYSTEM AND METHOD FOR GENERATING A NATURAL LANGUAGE ANSWER FOR ONE OR MORE USER QUERIES

(71) Applicant: Flipkart Internet Private Limited, Bengaluru (IN)

(72) Inventors: Anand A. RAJASEKAR, Chennai (IN); Nikesh GARERA, Bengaluru (IN)

(73) Assignee: Flipkart Internet Private Limited, Bengaluru (IN)

(21) Appl. No.: 17/885,835

(22) Filed: Aug. 11, 2022

(30) Foreign Application Priority Data
Aug. 14, 2021 (IN) 202141036893

(51) Int. Cl. G06F 16/332; G06F 16/33

(52) U.S. Cl. CPC G06F 16/3329; G06F 16/3344

(57) ABSTRACT

A system and method for generating a natural language answer for one or more user queries. The method encompasses receiving, the one or more user queries. Further the method leads to receiving, an information comprising at least one set of candidates, from a plurality of information sources. The method further comprises identifying, a set of target candidates from the at least one set of candidates based on a relevancy score. Thereafter the method encompasses removing, one or more ambiguities present in the set of target candidates based at least on a sentiment analysis. The method further comprises identifying, a set of relevant candidates from the set of target candidates based on the removal of the one or more ambiguities. Further the method encompasses generating, the natural language answer for the one or more user queries based at least on their corresponding set of relevant candidates.

### TECHNICAL FIELD

The present invention generally relates to automatic response generation and more particularly to systems and methods for generating a natural language answer for one or more user queries based on information received for said one or more user queries from different sources.

### BACKGROUND OF THE DISCLOSURE

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

The rapid growth in digital technologies over the past few years has also enhanced digital facilities provided to users of electronic devices. As a result of the enhancement in the digital technologies and digital facilities provided to the users, the number of users on digital platforms are also increasing at a very rapid rate. Therefore, a significant increase in number of user queries on the digital platforms is also recorded constantly over a period of time.

Every day, on the digital platforms such as an e-commerce platform, the users post millions of questions about product(s) that they are interested in purchasing before purchasing the product. Generally, unless these questions are answered by user(s) who purchased the product(s), they go unanswered. It is vital for such questions to be answered as soon as possible in order to help the users make a purchase decision.

Therefore, to deal with the huge number of user queries on digital platforms such as on the e-commerce platforms, various solutions related to automatic question answering systems are developed time to time. Also, the automatic question answering solutions that aims at solving product related questions has gained a lot of attention in recent years due to their extensive application in the e-commerce space. Furthermore, the automatic question answering is an important yet challenging task in the e-commerce space. One of the primary challenges present in building a real world answer generation solution for the digital platforms is noise present in data collected for answer generation, as such data mainly consists of user posted questions and answers having noise such as spelling errors, grammatical inconsistencies and sometimes code switching. Another common problem is the presence of irrelevant information and ambiguity in opinions/sentiments of users present in such data.

Further, some of the currently known solutions related to automatic question answering encompasses selecting a particular answer from a set of candidate/reference answers based on ranking strategies, for instance such known solutions encompasses retrieving a most similar question corresponding to a user query from a list of question answer pairs and using the corresponding answer as the response to the user query. Therefore, these solutions are limited to selection of an answer to a user query as a final result based on a ranking system and fails to generate a natural language answer to provide an efficient and effective response to the user query. Also, some of the known solutions provides solution of building a binary classifier to answer user queries with “Yes/No” answer. The problem with this approach is that it can answer only dichotomous questions and cannot handle subjective questions. Furthermore, the currently known solutions in the e-commerce space mainly provides the answers to the user queries based on customers/users reviews and fails to consider other data sources to generate relevant answers. The currently known solutions also fails to efficiently remove the noise, irrelevant data and ambiguity in opinions/sentiments of the users present in the data to generate an appropriate response to a user query.

Hence, there is a great demand for automatic answer generation solutions that can provide quick and accurate responses to one or more user queries received on digital platforms, using related information. Therefore, there is a need in the art to provide a solution for generating a natural language answer for one or more user queries based on information received from different sources.

### SUMMARY OF THE DISCLOSURE

This section is provided to introduce certain objects and aspects of the present invention in a simplified form that are further described below in the detailed description. This summary is not intended to identify the key features or the scope of the claimed subject matter.

In order to overcome at least some of the drawbacks mentioned in the previous section and those otherwise known to persons skilled in the art, an object of the present invention is to provide a method and system for generating a natural language answer for one or more user queries. Another object of the present invention is to provide a solution that can work for all type of questions to generate accurate responses. Also, an object of the present invention is to combine knowledge from multiple sources of information associated with digital platforms such as e-commerce platforms after removing irrelevant and ambiguous information (such as noise, irrelevant data and sentiment based ambiguities), to aid in answer generation for various type of questions. Another object of the present invention is to generate coherent and precise answers compared to prior known solutions.

Furthermore, in order to achieve the aforementioned objectives, the present invention provides a method and system for generating a natural language answer for one or more user queries.

A first aspect of the present invention relates to the method for generating a natural language answer for one or more user queries. The method encompasses receiving, at an input unit, the one or more user queries. Further the method leads to receiving, at the input unit, an information from a plurality of information sources, wherein the information comprises at least one set of candidates for each user query from the one or more user queries. The method further comprises identifying, by an identification unit, a set of target candidates from the at least one set of candidates for each user query from the one or more user queries, wherein said identification of the set of target candidates is based on a relevancy score between said each user query and each candidate of the at least one set of candidates. Thereafter the method encompasses removing, by a processing unit, one or more ambiguities present in the set of target candidates based at least on a sentiment analysis. The method further comprises identifying, by the processing unit, a set of relevant candidates from the set of target candidates based on the removal of the one or more ambiguities. Further the method encompasses generating, by the processing unit, the natural language answer for each user query from the one or more user queries based at least on the set of relevant candidates.

Another aspect of the present invention relates to a system for generating a natural language answer for one or more user queries. The system comprises an input unit, configured to receive, the one or more user queries. The input unit is further configured to receive, an information from a plurality of information sources, wherein the information comprises at least one set of candidates for each user query from the one or more user queries. Further the system comprises an identification unit, configured to identify, a set of target candidates from the at least one set of candidates for each user query from the one or more user queries, wherein said identification of the set of target candidates is based on a relevancy score between the one or more user queries and each candidate of the at least one set of candidates. Also, the system further comprises a processing unit, configured to remove, one or more ambiguities present in the set of target candidates based at least on a sentiment analysis. The processing unit is thereafter configured to identify, a set of relevant candidates from the set of target candidates based on the removal of the one or more ambiguities. Further the processing unit is configured to generate, the natural language answer for each user query from the one or more user queries based at least on the set of relevant candidates.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an exemplary block diagram of a system [100] for generating a natural language answer for one or more user queries, in accordance with exemplary embodiments of the present invention.

FIG. 2 illustrates an exemplary method flow diagram [200], for generating a natural language answer for one or more user queries, in accordance with exemplary embodiments of the present invention.

The foregoing shall be more apparent from the following more detailed description of the disclosure.

### DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “a user equipment”, “a user device”, “a smart-user-device”, “a smart-device”, “an electronic device”, “a mobile device”, “a handheld device”, “a wireless communication device”, “a mobile communication device”, “a communication device” may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from a processing unit, an input unit, an identification unit, a storage unit and any other such unit(s) which are required to implement the features of the present disclosure.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the system to perform their respective functions.

As disclosed in the background section the existing technologies have many limitations and in order to overcome at least some of the limitations of the prior known solutions, the present disclosure provides a solution for generating an accurate natural language answer for one or more user queries based on information received for said one or more user queries from multiple information sources. In a preferred implementation the present invention provides a solution to automatically generate an accurate natural language answer for one or more user queries in an e-commerce space using an information from multiple information sources such as reviews, duplicate/similar questions and/or their corresponding answers and specifications. More particularly, to generate the natural language answer for the one or more user queries, the present invention firstly encompasses removing irrelevant contents and sentiment related ambiguities from candidates/data available to generate the natural language answer, in the information received from the multiple information sources for said one or more user queries. Once the irrelevant contents and sentiment related ambiguities are removed, the present invention encompasses generating the natural language answer for the one or more user queries by summarizing information present in final candidates (i.e. the candidates/data left after removing irrelevant contents and sentiment related ambiguities).

Therefore, the present invention provides a novel technical solution that overcomes the technical problems related to presence of irrelevant information and the presence of ambiguity of sentiment in an information used to generate an answer to a user query on a digital platform, by performing relevancy and ambiguity prediction and removal before generating the answer/response to the user query. Also, the present invention provides a technical solution to automatically generate natural language answer for all type of questions using an information received from multiple information sources. The present invention also provides a technical advancement over currently known solutions that are limited to building a binary classifier for answering user queries with “Yes/No” answer and cannot handle non dichotomous questions. Also, the present invention provides a technical advancement over the currently known solutions that are limited to selection of an answer to a user query as a final result based on ranking system(s) and fails to generate a natural language answer. Furthermore, in order to implement the features of the present invention, in an implementation the current solution encompasses use of transformer based architectures at least to perform natural language task(s) and generate coherent and precise natural language answer for the one or more user queries.

Hereinafter, exemplary embodiments of the present disclosure will be described in detail with reference to the accompanying drawings so that those skilled in the art can easily carry out the present disclosure.

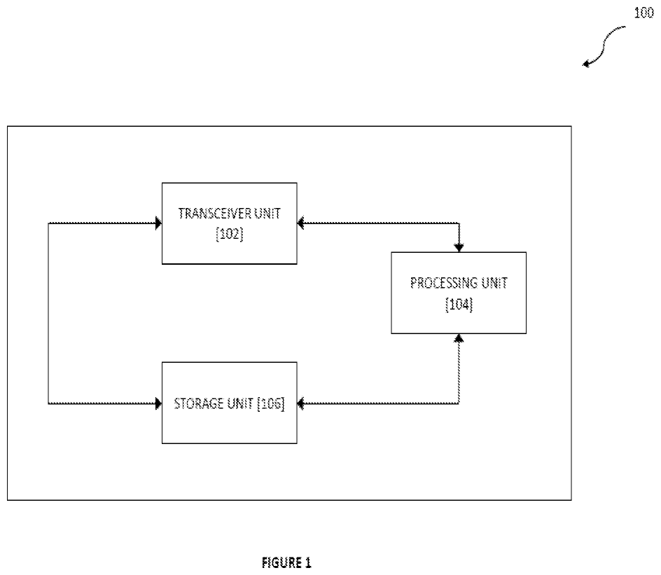

Referring to FIG. 1, an exemplary block diagram of a system [100] for generating a natural language answer for one or more user queries is shown. The system [100] comprises at least one input unit [102], at least one identification unit [104], at least one processing unit [106] and at least one storage unit [108]. Also, all of the components/units of the system [100] are assumed to be connected to each other unless otherwise indicated below. Also, in FIG. 1 only a few units are shown, however, the system [100] may comprise multiple such units or the system [100] may comprise any such numbers of said units, as required to implement the features of the present disclosure. Further, in an implementation, the system [100] may be present in a server device to implement the features of the present invention.

The system [100] is configured to generate a natural language answer for one or more user queries, with the help of the interconnection between the components/units of the system [100]. Also, in a preferred implementation the system [100] is implemented in an e-commerce space to generate the natural language answer for the one or more user queries, but the implementation of the system [100] is not limited only to the e-commerce space.

In order to generate the natural language answer for the one or more user queries, the input unit [102] is configured to receive, the one or more user queries. The one or more user queries comprises one or more questions received as an input from one or more users. The one or more user questions may include but not limited to at least one of one or more subjective questions, one or more WH questions, one or more dichotomous questions and any other kind of questions. Also, in an example, the one or more user queries may include but not limited to one or more user queries related to one or more offers, delivery of product(s), one or more product information and the like.

The input unit [102] is further configured to receive, an information from a plurality of information sources, wherein the information comprises at least one set of candidates for each user query from the one or more user queries to generate the natural language answer for said each user query from the one or more user queries. The plurality of information sources comprises at least one of one or more review related information sources, one or more duplicate question and answer related information sources, and one or more specification related information sources. In an implementation where the system [100] is configured in the e-commerce space, the one or more review related information sources comprises one or more review sections, wherein each review section comprising of one or more customer reviews, the one or more duplicate question and answer related information sources comprises one or more question and answer sections, wherein each question and answer section comprising of one or more questions and their corresponding answers, the one or more specification related information sources comprises one or more specification sections, wherein each specification section comprising of an information of one or more products.

Also, each set of candidates from the at least one set of candidates comprises one or more candidates/data to generate the natural language answer for each user query from the one or more user queries. In an example, if a user query related to screen quality of a product ABC is received, in such instance, a set of candidates may comprise at least one of one or more reviews related to the product ABC and/or screen quality of the product ABC, one or more question answers related to the product ABC and/or screen quality of the product ABC and a product specification detail indicating the screen quality of the product ABC.

Also, a few exemplary candidates of the at least one set of candidates (i.e. question answer pairs along with their information candidates) are tabulated below in Table 1:

TABLE 1

| | Example 1 | Example 2 |
|---|---|---|
| Question | display are very slow in | does phn have theatre |
| | ABC? | sound quality? |
| Reference Answer | my mobile display slow | Yes, the audio quality of |
| | | this phone is too good |
| Duplicate | 1) At present now on | 1) How is the sound |
| Q&A (Partial) | words which is better | quality? Is the sound |
| | ABCi or | better than ABC note 6? |
| | ABC? And mainly | XYZ 10 lite best sound |
| | display which is | quality |
| | better? ABC. | |
| Reviews | 1) ABC mobile | 1) sound quality is |
| | overall good but | very low class |
| | display quality | 2) Sound quality is |
| | poor | not good |
| | 2) but the display of | |
| | ABC are not good | |
| Specifications | 1) Other Display | 1) Sound Enhancements: |
| | Features: . . . Narrow | . . . Noise Reduction: |
| | Frame: 2.05 mm, | Dual microphone |
| | Screen Ratio: | Noise |
| | 2) Display Colors: 16.7M | |
| | 3) Display Size: 15.8 cm | |
| | (6.22 inch) | |

Thereafter, the identification unit [104] is configured to identify, a set of target candidates from the at least one set of candidates for each user query from the one or more user queries, wherein said identification of the set of target candidates is based on a relevancy score between said each user query from the one or more user queries and each candidate of the at least one set of candidates. The more a candidate is relevant to a user query from the one or more user queries, the more is the relevancy score between said user query from the one or more user queries and said candidate. In an implementation, top ‘k’ candidates from all the candidates of the at least one set of candidates are identified as target candidate(s), based on the relevancy score between each user query from the one or more user queries and the each candidate of the at least one set of candidates. Therefore, each target candidate from the one or more target candidates is a candidate/data that is highly relevant to each user query from the one or more user queries. For example, if a user query related to camera quality of a product CBA is received, in such instance, a target candidate may be one of a review, question-answer and specification related to the camera quality of the product CBA. In the given example, a set of target candidates comprising at least one target candidate is identified from at least one set of candidates comprising one or more candidates/data required to generate the natural language answer for the user query (for instance in the given example the set of target candidates may comprises one or more reviews, one or more question-answers and a specification related to the product CBA).

Furthermore, the relevancy score between each user query from the one or more user queries and each candidate of the at least one set of candidates is determined based on a first subsystem, wherein the first subsystem is trained based on a first dataset comprising of multiple user queries. In an implementation the multiple user queries are user posted questions on the e-commerce platform. Also, in one of the implementation, the first dataset is manually labeled to indicate whether each candidate of the at least one set of candidates has relevant information to answer each corresponding user query from the one or more corresponding user queries. In one another implementation, the first dataset may comprise multiple questions with corresponding reference answers that are not manually labelled to indicate whether the each candidate of the at least one set of candidates has relevant information to answer each corresponding user query from the one or more corresponding user queries. More particularly, to determine the relevancy score, each user query is matched with each candidate of the at least one set of candidates to determine whether the candidate(s) of the at least one set of candidates has highly relevant information to answer said query, wherein such determining of the relational information (i.e. the relevancy score) is further based on the first subsystem. Further, based on the relevancy between each user query from the one or more user queries and the each candidate (i.e. capability of the each candidate to answer each user query from the one or more user queries), the relevancy score between each user query from the one or more user queries and the each candidate is determined, wherein said relevancy score is directly proportional to the relevancy between each user query from the one or more user queries and the each candidate. In an implementation, to determine the relevancy score between each user query from the one or more user queries and the each candidate of the at least one set of candidates, one or more relevancy prediction models that are trained and evaluated using the first dataset may be one or more transformer model(s) fine-tuned on Next Sentence Prediction task, where one or more relevancy prediction tasks are modeled as a Next Sentence Prediction approach with a user query/question as a first sentence and the each candidate from the at least one set of candidates as a potential second sentence, such that a candidate that is relevant for answering the user query is a sentence immediately following it in a paragraph and other sentence(s)/candidate(s) that are irrelevant are random sentence. Thus, the important and relevant candidate(s) are identified by the identification unit [104] efficiently from the random sentence(s)/candidate(s). Further, based on such identification of the important and relevant candidate(s), using the relevancy prediction models, the relevancy score between each user query from the one or more user queries and the each candidate is determined, to further identify the set of target candidates from the at least one set of candidates. In an implementation the first dataset (i.e. a relevancy prediction dataset) is used to train relevancy prediction models such as RoBERTa-A, BERT-A, RoBERTa-QA, BERT-QA etc. to implement the features of the present invention.

Furthermore, an experimental analysis of a comparison of relevancy prediction for a baseline model and various relevancy prediction models trained based on an exemplary first dataset indicates that precision of a baseline model BERT-base is quite low proving that its ability to pick the relevant candidates is lower. Also, in said experimental analysis a first variant that utilizes only duplicate answer as second sentence for prediction (i.e. BERT-A and RoBERTa-A), and a second variant that uses both duplicate question and answer for prediction (i.e. BERT-QA and RoBERTa-QA) were considered, wherein for these two variants remaining information sources (for instance reviews related information source and/or specifications related information source) remain the same. Both the variants fine-tuned from BERT perform better than their counterparts owing to BERT being pre trained on NSP task. The models, BERT-A and RoBERTa-A have a moderate performance compared to QA variants due to the lack of duplicate question information. BERT-QA has the best performance because it combines best of both worlds; NSP pre-training and QA information. In a preferred implementation BERT-QA is the relevancy prediction model to implement the features of the present invention, however the scope of the present invention is not limited thereto.

Also, once the top ‘k’ candidates i.e. the one or more target candidates are identified, the identification unit [104] is configured to identify said one or more target candidates as the set of target candidates from the at least one set of candidates. The set of target candidates comprises the one or more target candidates in a ranked order, wherein the ranking of the one or more target candidates is based on a relevancy score between said each user query from the one or more user queries and the one or more target candidates of the set of target candidates. For example, if a relevancy score between a user query and a review (i.e. a first target candidate) is 75% and if a relevancy score between said user query and an answer to a duplicate question of the user query (i.e. a second target candidate) is 65%, the review (i.e. the first target candidate) in this example is ranked higher than the duplicate question based on the higher relevancy score.

More particularly, the candidates of the at least one set of candidates are sometimes repetitive in their ability to answer said each user query from the one or more user queries.

Also, using many candidates for generation of the natural language answer for each user query from the one or more user queries increases computation time and chances of loss of right information to generate the natural language answer. Therefore, to overcome such limitations, the identification unit [104] is configured to identify the set of target candidates from the at least one set of candidates based on the relevancy score between each user query from the one or more user queries and each candidate of the at least one set of candidates.

Further, the processing unit [106] is configured to remove, one or more ambiguities present in the set of target candidates based at least on a sentiment analysis. The sentiment analysis comprises identifying by the processing unit [106] a majority sentiment present in the set of target candidates. More particularly, the processing unit [106] is configured to identify one or more candidates (i.e. the one or more target candidates) of the set of target associated with one or more sentiments apart from the majority sentiment present in the set of target candidates as the one or more ambiguities. The processing unit [106] is thereafter configured to remove said one or more ambiguities i.e. the one or more target candidates associated with the one or more sentiments apart from the majority sentiment present in the set of target candidates, from the set of target candidates. More particularly, in most of the implementations apart from irrelevancy, one other reason for unnecessary information being considered while answering a user query is presence of ambiguity in target candidate(s) of said user query (for instance, due to the subjective nature of user queries), the processing unit [106] is therefore configured to remove the one or more ambiguities (i.e. the one or more minority sentiments). For example, if a set of target candidates comprises a positive sentiment as a majority sentiment with respect to a user query related to a quality of a product (i.e. negative and/or neutral sentiments present in the set of target candidates are lesser as compared to the positive sentiment), the processing unit [106] in the given instance is configured to identify one or more target candidates associated with the negative and/or the neutral sentiments as the one or more ambiguities. Further, the processing unit [106] is configured to remove such one or more ambiguities i.e. the one or more candidates associated with the negative and/or the neutral sentiments from the set of target candidates. In an implementation, the removal of the one or more ambiguities present in the set of target candidates is further based on a pre-trained subsystem trained based on an open source dataset comprising of multiple sets of candidates associated with different sentiments. Also, in an implementation a pre-trained subsystem such as a T5 model is used for ambiguity prediction. During training of such model the one or more sentiments that are in contrast with a label are filtered out and during evaluation, the sentiment that is expressed in most of the candidates is kept i.e. minority sentiments are eliminated. In an implementation the sentiment filtering is not performed on WH questions present in the one or more user queries. Further, in an instance, when both positive and negative sentiments together are passed as inputs to a generation model during training with a ground truth label containing any of the two sentiment, it hinders the model from learning to generate a response with the right sentiment. For e.g., two data points with the same question and candidates using conflicting answers given by two users as ground truth labels confuse the model whereas filtering the candidates to match the sentiment of the label helps the model to generate a response with sentiment present in the input. Hence, candidates with opposite sentiments to that of the label are removed and the advantage of removing this ambiguity is twofold. First, the number of input candidate decreases improving the computation time and second, the model gets trained to generate the answer with the sentiment which is given as input. During evaluation, the sentiment of the candidates to be given as input can be chosen using any heuristic and the generated answer contains the chosen sentiment. However, in an implementation this task is carried out only for dichotomous (yes/no) questions, as the candidates of WH questions are usually less subjective and hence, they are left untouched.

Further, the processing unit [106] is configured to identify, a set of relevant candidates from the set of target candidates based on the removal of the one or more ambiguities. More particularly, the processing unit [106] is configured to identify the set of relevant candidates based on the one or more target candidates associated with the majority sentiment present in the set of target candidates. Considering the above example, where the processing unit

is configured to remove the one or more ambiguities i.e. the one or more target candidates associated with the negative and/or the neutral sentiments from the set of target candidates, in such instance the processing unit [106] is further configured to identify a set of relevant candidates from the set of target candidates based on the removal of the one or more target candidates associated with the negative and/or the neutral sentiments. More particularly, the set of relevant candidates in the given instance encompasses the one or more target candidates associated with the majority sentiment i.e. the positive sentiment.

The processing unit [106] is further configured to generate, the natural language answer for each user query from the one or more user queries based at least on the set of relevant candidates. Also, the processing unit [106] is configured to concatenate and tokenize each user query from the one or more user queries and the set of relevant candidates to generate the natural language answer for said each user query from the one or more user queries. The processing unit [106] is also further configured to generate the natural language answer for each user query from the one or more user queries based on a second subsystem, wherein the second subsystem is trained based at least on a second dataset comprising of multiple user queries and answers of said multiple user queries. In an implementation, the multiple user queries and the answers of said multiple user queries are multiple user posted questions and their answers on the e-commerce platform. Also, in an implementation the second dataset (i.e. the dataset to train the second subsystem) may also comprise a data associated with multiple reviews and/or various specifications along with the multiple user queries and the answers of said multiple user queries. Also, in an implementation the second subsystem is trained after removing one or more irrelevant components and one or more sentiment related ambiguities from at least one of the multiple user queries and the answers of said multiple user queries, and multiple reviews . More particularly, once the set of relevant candidates is generated, the processing unit [106] is configured to concatenate and tokenize each user query from the one or more user queries and the set of relevant candidates. Thereafter, the processing unit [106] is configured to generate via the second subsystem, the natural language answer for each user query from the one or more user queries based on said each concatenated and tokenized user query and set of relevant candidates.

In an implementation, to generate the natural language answer for each user query from the one or more user queries, one or more answer generation models (i.e. second subsystem(s)) such as a text to text transformer model may be fine-tuned on a large question answer dataset (i.e. on the second dataset) to generate the accurate and precise response to the one or more user queries. Also, in such implementations, ground truth labels of the second dataset may be noisy since they represent individual opinion of one or more users. Furthermore, in an implementation, answer generation models such as Seq2Seq, HSSC-q and T5-QA etc. may be fine-tuned based on the second dataset (i.e. answer generation dataset) before filtering the irrelevant candidates and sentiment ambiguities, in order to further implement the features of the present invention.

Further, an experiment is performed to analyze performance of the present solution as compared with baselines, where T5-Base, Seq2Seq and HSSC-q are the baselines and T5-QA, MSQAP (rel. only), MSQAP (full) are the answer generation variants, and where Seq2Seq, HSSC-q T5-QA are trained based on the second dataset. The MSQAP (rel. only) is trained based on the second dataset after removing the irrelevant candidates and the MSQAP (full) is trained based on the second dataset after removing the irrelevant candidates and sentiment ambiguities. The T5-QA model denotes answer generation component, while MSQAP (rel.) denotes generation model with only relevancy prediction and MSQAP (full) denotes the answer generation model with both the relevancy prediction and ambiguity removal.

The experimental analysis indicated that answer generation models trained based on the second dataset by implementing of the features of the present invention report the highest performance in content preservation metrics such as ROGUE and BLEU.

Further, a case study of answers generated based on the above indicated baselines and the answer generation models trained based on the second dataset is provided as below in Table 2:

TABLE 2

Question (i.e. user query): is this gorilla glass
in this device . . . ??
Reference Answer (i.e. target candidate): no you
have to protect at your own
T5-base: Has it gorilla glass?
Seq2Seq: no, it has gorilla glass
HSSC-q: yes gorilla glass 3
T5-QA: No, it's not gorilla glass.
MSQAP(rel.): No, it has no gorilla glass.
MSQAP(full): No, it is not gorilla glass.
Question (i.e. user query): sound quality and
heating problem?
Reference Answer (i.e. target candidate): no issue
at all and sound is great
T5-base: Hang
Seq2Seq: sound quality is good
HSSC-q: sound quality is good
T5-QA: sound quality is good but heating problem
is there
MSQAP(rel.): sound quality is good but heating
problem is there
MSQAP(full): sound quality is good and no
heating problem

Therefore, Table 2 clearly indicates the answer generation models fine-tuned based on the second dataset, generates coherent and precise answers handling most spelling mistakes. Also, in a preferred implementation MSQAP (full) is the answer generation model to implement the features of the present invention as it generates the most coherent and precise answers for the user queries. Furthermore, various exemplary responses generated via the T5-QA, MSQAP (rel. only) and MSQAP (full) are depicted below in Table 3:

TABLE 3

Question (i.e. user query): will u give headphone
in the mobile box inside?
Reference Answer (i.e. target candidate): yes it
includes earphone also
T5-QA: No, you have to buy it separately.
MSQAP (rel. only): yes, earphones are there
MSQAP (full): yes, earphones are there
Question (i.e. user query): How can used to 2nd
back camera?
Reference Answer (i.e. target candidate): In
portrait mode, both cameras work simultaneously
T5-QA: it's a portrait mode . . .
MSQAP(rel.): Open the camera app and click on
the left side of the camera icon.
Then click on
MSQAP(full): Open the camera app and click
on the portrait mode.
Question (i.e. user query): is there 3 gb ram
version avilable?
Reference Answer (i.e. target candidate):
no never .4 GB ram please
T5-QA: No, 4 gb ram variant is not available.
MSQAP(rel.): No, 4 gb ram variant is not available.
MSQAP(full): No, it's 4 gb ram

Therefore, Table 3 clearly indicates that the MSQAP (full) generates the most coherent and precise answers for the user queries.

Also, a human evaluation of various answers generated (via T5-QA and MSQAP (full) models) based on the implementation of the features of the present invention is achieved, wherein a generated answer is labelled by human annotators correct w.r.t candidates if information present in the candidates is accurately reflected in the generated response. Also, correctness w.r.t label is measured by checking if the generated response(s) matches with ground truth answer.

Further, the human annotators also evaluated that if a question can be answered with an information present in corresponding candidate(s). This measure is called answerability. Based on an exemplary dataset that labeled for evaluation, an answerability of said dataset found to be 65.66%. There is slight improvement observed in correctness w.r.t context in MSQAP when compared to generation model (T5-QA) which is attributed to relevancy prediction. However, huge improvement in correctness w.r.t label can be attributed to both the components. Furthermore, generating answers for dichotomous questions is an easier task and hence, the performance is relatively high in such cases. Also, the correctness and answerability may vary with a variation in dataset(s) considered for evaluation.

Furthermore, in an implementation, the one or more answer generation models and one or more ambiguity prediction models (i.e. the one or more pre-trained subsystems) can be implemented together and trained in an end to end fashion, to further incorporate both answer generation and ambiguity prediction as part of a training process as compared to separate modules. Also, in an implementation weak candidates retrieval models are employed for each source (for instance for reviews related information source, duplicate questions and answers related information source or specifications related information source) in order to eliminate most unlikely candidates before constructing the first dataset and the second dataset.

Also, once the natural language answer for each user query from the one or more user queries is generated by the processing unit [106], the processing unit [106] is further configured to provide the generated natural language answer for each user query from the one or more user queries to the one or more users using one or more output units such as including but not limited to a display unit to display the generated natural language answer, an audio unit such as a speaker to provide the generated natural language answer as an audio response and the like. Furthermore, in an implementation the natural language answer for each user query from the one or more user queries may be provided to the users in multiple languages based on a translation of one or more user queries received in a new language into English to generate the natural language answer. Further, such generated natural language answer is translated from English to at least one of said new language and one or more user preferred language to provide response.

Also, in an implementation, the processing unit [104] is configured to provide the one or more users, one or more candidates from the at least one set of candidates along with the natural language answer generated for each user query from the one or more user queries, wherein said one or more candidates are the candidate(s) based on which the natural language answer for each user query from the one or more user queries is generated. Therefore, said one or more candidates are provided as an evidence from the at least one set of candidates that led to the generation of the natural language answer. In an implementation, the processing unit [106]

is configured to compute such evidence by picking one or more candidates with high attention scores or similarity metrics with the generated natural language answer, from the at least one set of candidates.

Also, in an implementation the natural language answer for each user query from the one or more user queries may be generated via a chat bot to maintain an automatic conversation on the digital platform such as the e-commerce platform.

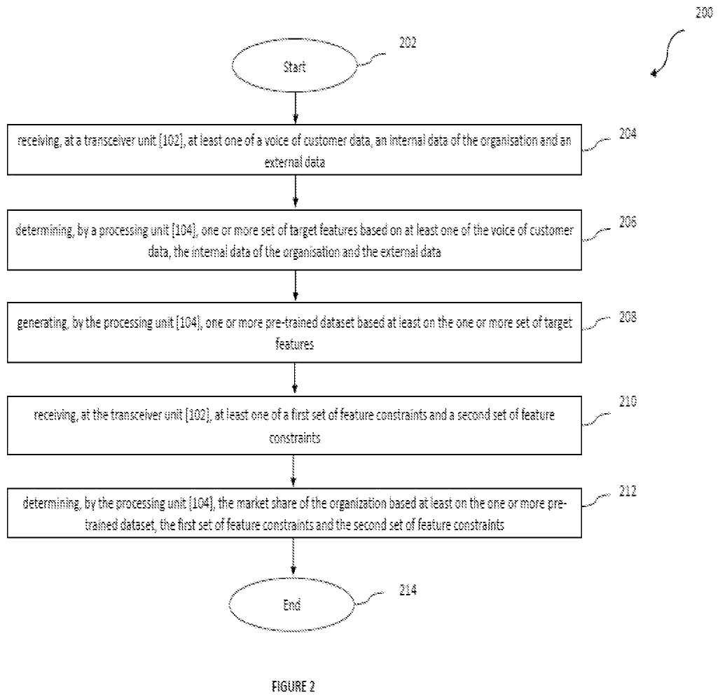

Referring to FIG. 2 an exemplary method flow diagram [200], for generating a natural language answer for one or more user queries, in accordance with exemplary embodiments of the present invention is shown. In an implementation the method is performed by the system [100] in an e-commerce space to generate the natural language answer for the one or more user queries, but the implementation of the method is not limited only to the e-commerce space. Further, in an implementation, the system [100] may be present in a server device to implement the features of the present invention. Also, as shown in FIG. 2, the method starts at step [202].

At step [204] the method comprises receiving, at an input unit [102], the one or more user queries. The one or more user queries comprises one or more questions received as an input from one or more users. The one or more user questions may include but not limited to at least one of one or more subjective questions, one or more WH questions, one or more dichotomous questions and any other kind of questions. Also, in an example, the one or more user queries may include but not limited to one or more user queries related to one or more offers available on an e-commerce platform, delivery of product(s), one or more product related information and the like.

Next at step [206] the method comprises receiving, at the input unit [102], an information from a plurality of information sources, wherein the information comprises at least one set of candidates for each user query from the one or more user queries to generate the natural language answer for said each user query from the one or more user queries. The plurality of information sources comprises at least one of one or more review related information sources, one or more duplicate question and answer related information sources, and one or more specification related information sources. In an implementation where the method is performed in the e-commerce space, the one or more review related information sources comprises one or more review sections, wherein each review section comprising of one or more customer reviews for a product for which a user query is received, the one or more duplicate question and answer related information sources comprises one or more question and answer sections, wherein each question and answer section comprising of one or more questions and their corresponding answers related to the product for which the user query is received, the one or more specification related information sources comprises one or more specification sections, wherein each specification section comprising of an information of the product for which the user query is received.

Also, each set of candidates from the at least one set of candidates comprises one or more candidates/data to generate the natural language answer for each user query from the one or more user queries. In an example, if a user query related to a battery performance of a product ABC is received, in such instance, the set of candidates may comprise at least one of: one or more reviews related to the battery performance of the product ABC, one or more question answers related to the product ABC and/or related to the battery performance of the product ABC, and a product specification detail indicating details of the battery the product ABC.

Further, at step [208] the method comprises identifying, by an identification unit [104], a set of target candidates from the at least one set of candidates for each user query from the one or more user queries, wherein said identification of the set of target candidates is based on a relevancy score between said each user query from the one or more queries and each candidate of the at least one set of candidates. The more a candidate is relevant to a user query, the more is the relevancy score between said user query and said candidate. In an implementation, top ‘k’ candidates from all the candidates of the at least one set of candidates are identified as target candidate(s), based on the relevancy score between each user query from the one or more user queries and the each candidate of the at least one set of candidates. Therefore, each target candidate from the one or more target candidates is a candidate/data that is highly relevant to corresponding the user query from the one or more user queries. For example, if a user query related to audio quality of a product XYZ is received, in such instance, a target candidate may be one of a review, question-answer and specification related to the audio quality of the product XYZ. Therefore, in the given example, a set of target candidates comprising at least one target candidate is identified from at least one set of candidates, wherein the at least one set of candidates comprises the one or more candidates/data to generate the natural language answer to the user query related to product XYZ (for instance one or more reviews, one or more question-answers and a specification related to the product XYZ may be received as the set of candidates).

Furthermore, the relevancy score between said each user query from the one or more queries and the each candidate of the at least one set of candidates is determined based on a first subsystem, wherein the first subsystem is trained based on a first dataset comprising of multiple user queries. In an implementation the multiple user queries are user posted questions on the e-commerce platform. Also, in one of the implementation, the first dataset is manually labeled to indicate whether the each candidate of the at least one set of candidates has relevant information to answer each corresponding user query from the one or more user queries. In one another implementation, the first dataset may comprise multiple questions with corresponding reference answers that are not manually labelled to indicate whether the each candidate of the at least one set of candidates has relevant information to answer each corresponding user query from the one or more user queries. More particularly, to determine the relevancy score, the method encompasses matching each user query with the each candidate of the at least one set of candidates to determine whether the candidate(s) of the at least one set of candidates has highly relevant information to answer said query, wherein such determining of the relevancy score is further based on the first subsystem. Further, based on the relevancy between each user query from the one or more user queries and the each candidate, the method encompasses determining the relevancy score between each user query from the one or more user queries and the each candidate, wherein said relevancy score is directly proportional to the relevancy between each user query from the one or more user queries and the each candidate.

In an implementation, to determine the relevancy score between each user query from the one or more user queries and the each candidate of the at least one set of candidates, the method encompasses training and evaluating one or more relevancy prediction models (i.e. the first subsystems) using the first dataset. Also, in one of the implementation, a relevancy prediction model is a transformer model fine-tuned on Next Sentence Prediction task, where one or more relevancy prediction tasks are modeled as a Next Sentence Prediction approach with a user query/question as a first sentence and the each candidate from the at least one set of candidates as a potential second sentence, such that a candidate that is relevant for answering the user query is a sentence immediately following it in a paragraph and other sentence(s)/candidate(s) that are irrelevant are random sentence. Thus, the method encompasses efficiently identifying by the identification unit [104], the important and relevant candidate(s) from the random sentence(s)/candidate(s). Further, based on such identification of the important and relevant candidate(s) and using the relevancy prediction models, the method encompasses determining the relevancy score between each user query from the one or more user queries and the each candidate, to further identify the set of target candidates from the at least one set of candidates.

Also, once the top ‘k’ candidates i.e. the one or more target candidates are identified, the method encompasses identifying by the identification unit [104], said one or more target candidates as the set of target candidates from the at least one set of candidates. The set of target candidates comprises the one or more target candidates in a ranked order, wherein the ranking of the one or more target candidates is based on a relevancy score between said each user query from the one or more user queries and the one or more target candidates of the set of target candidates. For example, if a relevancy score between a user query and a first review (i.e. a first target candidate) is 55% and if a relevancy score between said user query and a second review (i.e. a second target candidate) is 45%, the first review (i.e. the first target candidate) in this example is ranked higher than the duplicate question based on the higher relevancy score.

Next, at step [210] the method comprises removing, by a processing unit [106], one or more ambiguities present in the set of target candidates based at least on a sentiment analysis. The sentiment analysis comprises identifying by the processing unit [106] a majority sentiment present in the set of target candidates.

More particularly, the method encompasses identifying by the processing unit [106], one or more candidates (i.e. the one or more target candidates) of the set of target associated with one or more sentiments apart from the majority sentiment present in the set of target candidates as the one or more ambiguities. Thereafter, the method encompasses removing by the processing unit [106], said one or more ambiguities i.e. the one or more target candidates associated with the one or more sentiments apart from the majority sentiment present in the set of target candidates, from the set of target candidates. For example, if a set of target candidates comprises a negative sentiment as a majority sentiment with respect to a user query related to a quality of a product (i.e. positive and/or neutral sentiments present in the set of target candidates are lesser as compared to the negative sentiment), the method in the given instance encompasses identifying by the processing unit [106], one or more target candidates associated with the positive and/or the neutral sentiments as the one or more ambiguities. Further, the method encompasses removing by the processing unit [106], such one or more ambiguities i.e. the one or more candidates associated with the positive and/or the neutral sentiments from the set of target candidates. In an implementation, the removal of the one or more ambiguities present in the set of target candidates is further based on a pre-trained subsystem trained based on an open source dataset comprising of multiple sets of candidates associated with different sentiments. Also, in an implementation a pre-trained subsystem such as a T5 model is used for ambiguity prediction.

Thereafter, at step [212] the method comprises identifying, by the processing unit [106], a set of relevant candidates from the set of target candidates based on the removal of the one or more ambiguities. More particularly, the method encompasses identifying by the processing unit [106], the set of relevant candidates based on the one or more target candidates associated with the majority sentiment present in the set of target candidates. Considering the above example, where the method encompasses removing the one or more ambiguities i.e. the one or more target candidates associated with the positive and/or the neutral sentiments from the set of target candidates, in such instance the method further comprises identifying by the processing unit [106], a set of relevant candidates from the set of target candidates based on the removal of the one or more target candidates associated with the positive and/or the neutral sentiments. More particularly, the set of relevant candidates in the given instance encompasses the one or more target candidates associated with the majority sentiment i.e. the negative sentiment.

Next, at step [214] the method comprises generating, by the processing unit [106], the natural language answer for each user query from the one or more user queries based at least on the set of relevant candidates. The process of generating, by the processing unit [106], the natural language answer for each user query from the one or more user queries comprises concatenating and tokenizing each user query from the one or more user queries and the set of relevant candidates. Also, the process of generating, by the processing unit [106], the natural language answer for each user query from the one or more user queries is further based on a second subsystem, wherein the second subsystem is trained based at least on a second dataset comprising of multiple user queries and answers of said multiple user queries.

In an implementation, the multiple user queries and the answers of said multiple user queries are multiple user posted questions and their answers on the e-commerce platform. Also, in an implementation the second dataset (i.e. the dataset to train the second subsystem) may also comprise a data associated with multiple reviews and/or various specifications along with the multiple user queries and the answers of said multiple user queries. Also, in an implementation the second subsystem is trained after removing one or more irrelevant components and one or more sentiment related ambiguities from at least one of the multiple user queries and the answers of said multiple user queries, and multiple reviews. More particularly, once the set of relevant candidates is generated, the method encompasses concatenating and tokenizing by the processing unit [106], each user query from the one or more user queries and the set of relevant candidates. Thereafter, the method comprises generating by the processing unit [106] via the second subsystem, the natural language answer for each user query from the one or more user queries based on said concatenated and tokenized user query and set of relevant candidates. In an implementation, to generate the natural language answer for each user query from the one or more user queries, one or more answer generation models (i.e. second subsystem(s)) may be trained based on the second dataset. For instance, for the natural language answer generation, a text to text transformer model may be fine-tuned on a large question answer dataset (i.e. on the second dataset) to generate the accurate and precise response to the one or more user queries. Also, in such implementations, ground truth labels of second dataset may be noisy since they represent individual opinion of one or more users.

Furthermore, in an implementation, the one or more answer generation models and one or more ambiguity prediction models (i.e. the one or more pre-trained subsystems) can be implemented together and trained in an end to end fashion, to further incorporate both answer generation and ambiguity prediction as part of a training process as compared to separate modules.

Also, once the natural language answer for each user query from the one or more user queries is generated, the method encompasses providing by the processing unit [106], the generated natural language answer for each user query from the one or more user queries to the one or more users using one or more output units such as including but not limited to a display unit to display the generated natural language answer, an audio unit such as a speaker to provide the generated natural language answer as an audio response and the like. Furthermore, in an implementation the natural language answer for each user query from the one or more user queries may be provided to the users in multiple languages based on a translation of one or more user queries received in a new language (i.e. language other than English) into English to generate the natural language answer. Further, such generated natural language answer is translated from English to at least one of said new language and one or more user preferred language to provide response.

Also, in an implementation, the method encompasses providing by the processing unit [104], to the one or more users, one or more candidates from the at least one set of candidates along with the natural language answer for each user query from the one or more user queries, wherein said one or more candidates are the candidate(s) based on which the natural language answer for each user query from the one or more user queries is generated. Therefore, said one or more candidates are provided as an evidence from the at least one set of candidates that led to the generation of the natural language answer. In an implementation, the method encompasses computing by the processing unit [106], such evidence by picking one or more candidates with high attention scores or similarity metrics with the generated natural language answer, from the at least one set of candidates.

Also, in an implementation the natural language answer for each user query from the one or more user queries may be generated via a chat bot to maintain an automatic conversation on the digital platform such as the e-commerce platform.

After providing the natural language answer for the one or more user queries, the method terminates at step [216].

Thus, the present invention provides a novel solution for automatically generating a coherent and precise natural language answer for one or more user queries. Also, the present invention provides a novel technical solution that overcomes the technical problems related to presence of irrelevant information and the presence of ambiguity of sentiment in an information used to generate an answer to a user query on a digital platform, by performing relevancy and ambiguity prediction and removal before generating the answer/response to the user query. Also, the present invention provides a technical solution to automatically generate natural language answer for all type of questions and therefore the present invention provides a technical advancement over currently known solutions that are limited to building a binary classifier for answering user queries with “Yes/No” answer and cannot handle subjective questions. Further the present invention also provides a technical advancement over the currently known solutions that are limited to selection of an answer to a user query as a final result based on ranking system(s) and fails to generate a natural language answer. Also, the present invention provides a solution that utilizes noisy answers submitted by users and reduces the need for supervised annotations of text spans required in training Question Answering models.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

1. A method for generating a natural language answer for one or more user queries, the method comprising:
receiving, at an input unit [102], the one or more user queries;
receiving, at the input unit [102], an information from a plurality of information sources, wherein the information comprises at least one set of candidates for each user query from the one or more user queries;
identifying, by an identification unit [104], a set of target candidates from the at least one set of candidates for each user query from the one or more user queries, wherein said identification of the set of target candidates is based on a relevancy score between said each user query and each candidate of the at least one set of candidates;
removing, by a processing unit [106], one or more ambiguities present in the set of target candidates based at least on a sentiment analysis;
identifying, by the processing unit [106], a set of relevant candidates from the set of target candidates based on the removal of the one or more ambiguities; and
generating, by the processing unit [106], the natural language answer for each user query from the one or more user queries based at least on the set of relevant candidates.

2. The method as claimed in claim 1, wherein the plurality of information sources comprises at least one of one or more review related information sources, one or more duplicate question and answer related information sources, and one or more specification related information sources.

3. The method as claimed in claim 1, wherein the relevancy score between each user query from the one or more user queries and each candidate of the at least one set of candidates is determined based on a first subsystem, wherein the first subsystem is trained based on a first dataset comprising of multiple user queries.

4. The method as claimed in claim 1, wherein the set of target candidates for each user query from the one or more user queries comprises one or more target candidates in a ranked order, wherein the ranking of the one or more target candidates is based on a relevancy score between said each user query from the one or more user queries and the one or more target candidates.

5. The method as claimed in claim 1, wherein the sentiment analysis comprises identifying by the processing unit [106] a majority sentiment present in the set of target candidates.

6. The method as claimed in claim 1, wherein generating, by the processing unit [106], the natural language answer for each user query from the one or more user queries further comprises concatenating and tokenizing said each user query and the set of relevant candidates.

7. The method as claimed in claim 6, wherein generating, by the processing unit [106], the natural language answer for each user query from the one or more user queries is further based on a second subsystem, wherein the second subsystem is trained based at least on a second dataset comprising of multiple user queries and answers of said multiple user queries.

8. A system for generating a natural language answer for one or more user queries, the system comprising:
an input unit [102], configured to:
receive, the one or more user queries, and
receive, an information from a plurality of information sources, wherein the information comprises at least one set of candidates for each user query from the one or more user queries;
an identification unit [104], configured to identify, a set of target candidates from the at least one set of candidates for each user query from the one or more user queries, wherein said identification of the set of target candidates is based on a relevancy score between said each user query and each candidate of the at least one set of candidates; and
a processing unit [106], configured to:
remove, one or more ambiguities present in the set of target candidates based at least on a sentiment analysis,
identify, a set of relevant candidates from the set of target candidates based on the removal of the one or more ambiguities, and
generate, the natural language answer for each user query from the one or more user queries based at least on the set of relevant candidates.

9. The system as claimed in claim 8, wherein the plurality of information sources comprises at least one of one or more review related information sources, one or more duplicate question and answer related information sources, and one or more specification related information sources.

10. The system as claimed in claim 8, wherein the relevancy score between each user query from the one or more user queries and each candidate of the at least one set of candidates is determined based on a first subsystem, wherein the first subsystem is trained based on a first dataset comprising of multiple user queries.

11. The system as claimed in claim 8, wherein the set of target candidates for each user query from the one or more user queries comprises one or more target candidates in a ranked order, wherein the ranking of the one or more target candidates is based on a relevancy score between said each user query from the one or more user queries and the one or more target candidates.

12. The system as claimed in claim 8, wherein the sentiment analysis comprises identifying by the processing unit [106] a majority sentiment present in the set of target candidates.

13. The system as claimed in claim 8, wherein the processing unit [106] is further configured to concatenate and tokenize said each user query and the set of relevant candidates to generate the natural language answer for the one or more user queries.

14. The system as claimed in claim 8, wherein the processing unit [106] is further configured to generate the natural language answer for each user query from the one or more user queries based on a second subsystem, wherein the second subsystem is trained based at least on a second dataset comprising of multiple user queries and answers of said multiple user queries.
